(19) United States
(12) Patent Application Publication
(10) Pub. No.: US 2024/0375145 A1
(43) Pub. Date: Nov. 14, 2024

(54) METHODS OF MAKING OMNIPHOBIC MATERIALS WITH HIERARCHICAL STRUCTURES AND USES THEREOF

(71) Applicant: McMaster University, Hamilton (CA)

(72) Inventors: Tohid Didar, Hamilton (CA); Leyla Soleymani, Oakville (CA); Shadman Khan, Toronto (CA)

(73) Assignee: McMaster University, Hamilton, ON (CA)

(21) Appl. No.: 18/683,578

(22) PCT Filed: Aug. 18, 2022
(86) PCT No.: PCT/CA2022/051259

§ 371 Date: Feb. 14, 2024

Related U.S. Application Data
(60) Provisional application No. 63/260,372, filed on Aug. 18, 2021.

(51) Int. Cl. B05D 1/00; B05D 5/08; C08J 7/12

(52) U.S. Cl. CPC B05D 1/62; B05D 5/086; C08J 7/12; C08J 2383/04

(57) ABSTRACT

This disclosure relates to methods of making omniphobic materials which are physically and chemically modified at their surface to create hierarchically structured materials with both nanoscale and microscale structures that provide the omniphobic properties. Uses thereof, including as flexible tubular structures that repel contaminants are also disclosed herein.

### CROSS-REFERENCE TO RELATED APPLICATIONS

The present application claims the benefit of priority from co-pending U.S. provisional patent application Ser. No. 63/260,372 filed on Aug. 18, 2021, the contents of which are incorporated herein by reference in their entirety.

### FIELD

The present disclosure relates to the field of materials engineering. In particular, the present disclosure relates to methods of making omniphobic materials with hierarchical structures and uses thereof.

### BACKGROUND

The fouling of surfaces caused by the adhesion of bacteria, blood, cells and proteins remains a problem within the biomedical space. Fouling can trigger infection as well as coagulation-driven thrombosis that can lead to thromboembolic complications and device failure. Within biosensors, the non-specific adsorption of biological entities present in complex fluids—such as whole blood and plasma, increases background noise, thereby reducing detection sensitivity. On a larger scale, the presence of pathogens on surfaces within clinical settings often leads to hospital-acquired infections with poor prognoses and high treatment costs.

Omniphobic, lubricant-infused surfaces have been developed via the locking of a lubricant layer onto the surface through intermolecular interactions between the surface and the lubricant. Such surfaces have garnered interest due to their antifouling properties towards bacteria and blood within both biomedical devices and biosensing platforms. One well-studied approach involves functionalizing surfaces with fluorine-based silanes for the immobilization of biocompatible perfluorocarbon lubricants through interactions between fluorine groups.^{[1]} While promising, these lubricant layers suffer from low stability under dynamic fluid flow, as would be experienced within various biomedical devices, resulting in a loss of repellency over time. To effectively use lubricant-infused surfaces for widespread antibiofouling purposes, increased lubricant retention is desirable. To this end, surface texturing has been identified as a means through which a lubricant layer can achieve greater stability and retention under flow.^{[2,3]} U.S. Pat. No. 9,121,307B2 describes slippery liquid-infused porous surfaces (SLIPS) comprising a roughened (e.g. porous) surface that can be utilized to lock in place a lubricating fluid. When microtextured surfaces are infused with lubricant, the structures that constitute its surface mediate the spreading of the lubricant across the surface through capillary wicking.^{[4]} Combined with intermolecular interactions between a treated surface and a matching lubricant, these capillary forces hold the lubricant layer in place. Yet, when exposed to more vigorous fluid flow, the shear stress experienced by the surface can act against capillary forces that help immobilize the lubricant layer, leading to its deterioration.^{[2]} Introducing hierarchy to microstructures through nanoscale modifications overcomes this barrier, since the presence of nanoscale entities substantially increases capillary forces.

To simplify the fabrication of lubricant-infused hierarchical surfaces, which would be expected to exhibit improved biological repellency and strong lubricant retention, a recent strategy successfully modified heat-shrinkable polystyrene using scalable chemical treatments to form hierarchical, micro and nano structured surfaces.^{[5]} WO2020243833A1 describes omniphobic materials which are physically and chemically modified at their surface to create hierarchically structured materials with both nanoscale and microscale structures that provide the omniphobic properties. The polystyrene substrates were first coated with a stiff layer consisting of nanoparticles and a fluorosilane. Subsequent heat shrinking resulted in the formation of microscale wrinkles with nanoscale features due to the difference in stiffness between the nanoparticle coating and the underlying polymer.^{[5,6]} While a promising technology, the resulting surfaces lack optical transparency due to their light-scattering nanoparticle coating and exhibit limited flexibility due to the inherent rigidity of the polymer substrate after shrinking. In the context of wearable devices, transparency avoids vision obstruction when such devices are mounted on the eye and reduces the visibility of skin-mounted devices. Transparency also enables the incorporation of optical sensing components into such devices, substantially increasing their capabilities. Concurrently, the limited flexibility of these surfaces limits their incorporation into applications that require non-planar form factors, such as tubular medical devices and wearable sensors.

### SUMMARY

The present disclosure provides a method of fabricating a material having a surface with hierarchical structures, the method comprising:
a) obtaining a mold comprising microscale wrinkles and nanoscale features,
b) depositing an elastomeric polymer onto the mold,
c) curing the elastomeric polymer on the mold,
d) removing the elastomeric polymer from the mold to expose a surface with hierarchical structures,
e) activating the elastomeric polymer by oxidation of the surface,
f) coating the surface with a lubricant-tethering molecule to create at least one lubricant-tethering molecular layer.

The present disclosure provides a method of fabricating a material having a surface with hierarchical structures, the method comprising:
a) providing a mold comprising microscale wrinkles and nanoscale features,
b) depositing an elastomeric polymer onto the mold,
c) curing the elastomeric polymer on the mold to provide a cured elastomeric polymer,
d) removing the cured elastomeric polymer from the mold to expose a surface of the cured elastomeric polymer with hierarchical structures,
e) activating the surface of the cured elastomeric polymer by oxidation,
f) coating at least a portion of the activated surface with a lubricant-tethering molecule to obtain at least one lubricant-tethering molecular layer on at least a portion of the activated surface of the elastomeric polymer.

The present disclosure provides a method of fabricating a material having a surface with hierarchical structures, the method comprising:
a) depositing a moldable polymer onto a mold comprising microscale wrinkles and nanoscale features,
b) curing the moldable polymer on the mold to provide a cured polymer, and
c) removing the cured polymer from the mold to expose at least a surface of the cured polymer with hierarchical structures.

In some embodiments, the method further comprises
d) activating at least the surface of the cured polymer by oxidation,
e) coating at least a portion of the activated surface with a lubricant-tethering molecule to obtain at least one lubricant-tethering molecular layer on at least a portion of the activated surface of the cured polymer.

The present disclosure provides a method of fabricating a material having a surface with hierarchical structures, the method comprising:
a) depositing a moldable polymer onto a mold comprising microscale wrinkles and nanoscale features,
b) curing the moldable polymer on the mold to provide a cured polymer,
c) removing the cured polymer from the mold to expose at least a surface of the cured polymer with hierarchical structures,
d) activating at least the surface of the cured polymer by oxidation,
e) coating at least a portion of the activated surface with a lubricant-tethering molecule to obtain at least one lubricant-tethering molecular layer on at least a portion of the activated surface of the cured polymer.

The present disclosure provides a method of fabricating a material having a surface with hierarchical structures, the method comprising:
a) depositing an elastomeric polymer onto a mold comprising microscale wrinkles and nanoscale features,
b) curing the elastomeric polymer on the mold to provide a cured elastomeric polymer,
c) removing the cured elastomeric polymer from the mold to expose a surface of the cured elastomeric polymer with hierarchical structures,
d) activating the surface of the cured elastomeric polymer by oxidation,
e) coating at least a portion of the activated surface with a lubricant-tethering molecule to obtain at least one lubricant-tethering molecular layer on at least a portion of the activated surface of the elastomeric polymer.

In some embodiments, the method further comprises depositing a lubricating layer on the at least one lubricant-tethering molecular layer after the coating.

In some embodiments, the method further comprises treating the mold with a anti-stick agent before the depositing.

In some embodiments, the moldable polymer is a pre-cured elastomeric polymer or a thermoplastic polymer. Accordingly, in some embodiments, the cured polymer is a cured elastomeric polymer or a cured thermoplastic polymer.

In some embodiments, the method further comprises subjecting the mold with the deposited moldable polymer to vacuum after the depositing.

In some embodiments, the activating of at least the surface of the cured polymer comprises plasma treatment.

In some embodiments, the coating of the surface with the lubricant-tethering molecule comprises chemical vapor deposition of the lubricant-tethering molecule onto the surface.

In some embodiments, the elastomeric polymer comprises a silicone elastomer.

In some embodiments, the elastomeric polymer is polydimethylsiloxane (PDMS).

In some embodiments, the lubricant-tethering molecule comprises a fluorosilane, a fluorocarbon, a fluoropolymer, an organosilane, a polysiloxane, or mixtures thereof.

In some embodiments, the lubricant-tethering molecular layer is a fluorosilane layer or monolayer and is formed using one or more compounds of the Formula I:

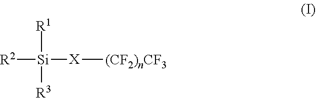

wherein X is a single bond or is C₁₋₆alkylene; n is an integer of from 0 to 12; and R¹, R² and R³ are each independently a hydrolysable group.

In some embodiments, the fluorosilane comprises trichloro(1H,1H,2H,2H-perfluorooctyl)silane (TPFS) or a fluorosilane of similar composition. In some embodiments, the fluorosilane comprises trichloro(1H,1H,2H,2H-perfluorooctyl)silane (TPFS), 1H,1H,2H,2H-Perfluorooctyltriethoxysilane (PFOTS), 1H, 1H, 2H, 2H-perfluorodecyltrichlorosilane (PFDTS), or mixtures thereof.

In some embodiments, the polysiloxane is formed using one or more compounds of Formula II:

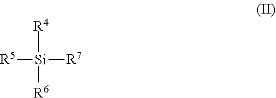

wherein R⁴, R⁵ and R⁶ are each independently a hydrolysable group; and R⁷ is C₁₋₃₀alkyl, optionally R⁷ is C₁₀₋₃₀alkyl, or C₂₀₋₃₀alkyl.

In some embodiments, the mold comprises a surface having hierarchical structures of microscale wrinkles and nanoscale features. In some embodiments, the hierarchical structures of the mold are formed using a process comprising heat shrinking. In some embodiments, the mold comprises at least one nanoparticle layer and at least one lubricant-tethering molecular layer. In some embodiments, the mold can be prepared using processes described in WO2020243833A1.

It can be appreciated that the components of the lubricating layer are to be selected to be compatible with the lubricant-tethering molecular layer. In some embodiments, the lubricating layer comprises hydrocarbon liquid, fluorinated organic liquid, or perfluorinated organic liquid.

In some embodiments, the lubricating layer comprises perfluoroperhydrophenanthrene (PFPP).

In some embodiments, the material is flexible.

In some embodiments, the material is transparent.

In some embodiments, the material exhibits repellency to liquids comprising biospecies.

In some embodiments, the material exhibits repellency to bacteria and biofilm formation.

In some embodiments, the material exhibits repellency to biological fluids.

In some embodiments, the material exhibits repellency to blood.

In some embodiments, the material attenuates coagulation.

In some embodiments, the material is not heat shrinkable. In some embodiments, the cured polymer is not heat shrinkable.

The present disclosure also provides a material comprising a surface with hierarchical structures prepared using the method disclosed herein.

The present disclosure also provides a device or article comprising the material disclosed herein.

In some embodiments, the material is on a surface of the device or article. In some embodiments, the material is present on more than one surface of the device or article.

The present disclosure also provides a device for preventing, reducing, or delaying adhesion, adsorption, surface-mediated clot formation, or coagulation of a biological material in contact therewith, comprising a low adhesion surface with hierarchical structures, at least one lubricant-tethering molecular layer and a lubricating layer, wherein the biological material is repelled from the surface. The present disclosure also provides a device comprising a low adhesion surface with hierarchical structures, wherein the surface comprises an elastomeric polymer, at least one lubricant-tethering molecular layer and a lubricating layer, wherein the surface comprises the material of the present disclosure, and wherein the surface is repellant against biological material. The present disclosure also provides a device of the present disclosure for use in preventing, reducing, or delaying adhesion, adsorption, surface-mediated clot formation or coagulation of a biological material in contact therewith.

The present disclosure also provides a method of preventing, reducing, or delaying adhesion, adsorption, surface-mediated clot formation, or coagulation of a biological material onto a device in contact therewith, the method comprising providing the device disclosed herein and contacting the biological material to the low adhesion surface. The present disclosure also provides a method of preventing, reducing, or delaying adhesion, adsorption, surface-mediated clot formation, or coagulation of a biological material onto a device or article comprising surface-treating the device or article with a material of the present disclosure to obtain a low adhesion surface on the device or article. In some embodiments, the surface-treating comprises coating the device with the material of the present disclosure. In some embodiments, the surface-treating comprises forming a surface or a plurality of surfaces of the device with the material of the present disclosure.

Other features and advantages of the present disclosure will become apparent from the following detailed description. It should be understood, however, that the detailed description and the specific examples, while indicating embodiments of the disclosure, are given by way of illustration only and the scope of the claims should not be limited by these embodiments, but should be given the broadest interpretation consistent with the description as a whole.

### DRAWINGS

Certain embodiments of the disclosure will now be described in greater detail with reference to the attached drawings in which:

FIG. 1 shows an overview of the developed hierarchically structured PDMS surface in exemplary embodiments of the disclosure: (a) schematic of the pattern transfer protocol used to prepare hierarchically structured PDMS substrates; (b) scanning electron microscopy images of the hierarchically structured PDMS substrates, with 1 μm and 100 nm scale bars, respectively; (c) optical images depicting the high degree of (i) transparency and (ii) flexibility of the hierarchically structured substrate; (d) schematic of the post-fabrication surface modifications for the infusion of lubricant.

FIG. 2 shows side-by-side comparison of (a) the hierarchically structured polystyrene mold and (b) the developed hierarchically structured PDMS surface, showing the structural features that were effectively transferred via casting (scale bars represent 1 μm) in exemplary embodiments of the disclosure.

FIG. 3 shows background fluorescence assessed in DAPI (a-b), FITC (c-d) and TRITC (e-f) channels in exemplary embodiments of the disclosure: comparative images show the wrinkled polystyrene mold (a, c, e) versus the hierarchically structured PDMS (b, d, f); scale bars represent 50 μm.

FIG. 4 shows characterization of the hierarchically structured PDMS and hierarchically structured-TPFS surfaces relative to planar control samples, with and without PFPP lubricant infusion, in exemplary embodiments of the disclosure: (a) contact angles of four substrate conditions with water and hexadecane (the table below the graph reports the sliding angle of water on the four tested substrates)—an inability to slide was denoted as a sliding angle >90°; (b) lubricant retention of four substrate conditions as measured by weight (significance is shown through asterisks corresponding to *P<0.05, **P<0.01 and ***P<0.001; all reported values are the mean of at least three samples and associated error bars represent standard deviation).

FIG. 5 shows results from a colony forming unit assay using MRSA in planar-TPFS and hierarchically structured-TPFS conditions in exemplary embodiments of the disclosure—data points are presented on a logarithmic scale and error bars represent standard error from the mean (each measurement consists of at least three data points; significance is shown through asterisks corresponding to **P<0.01).

FIG. 6 shows bacterial adhesion, blood repellency and antithrombogenicity studies under static test conditions in exemplary embodiments of the disclosure: (a) colony forming unit assay performed for four classes of surfaces using (i) MRSA and (ii) P. aeruginosa (depicted on a logarithmic scale and error bars represent standard error from the mean; each measurement consists of at least three data points); (b) contact angles of human whole blood on planar and hierarchically structured PDMS; (c) blood staining assay on six substrate conditions, normalized to the planar mean value, alongside representative optical images; (d) thrombin generation values of six substrate conditions graphed over the duration of the assay—associated table quantitatively summarizes the performance of each condition in the context of four performance indicators (significance is shown through asterisks corresponding to *P<0.05, **P<0.01 and ***P<0.001; for (b)-(d), all reported values are the mean of at least three samples and associated error bars represent standard deviation from the mean).

FIG. 7 shows bacterial repellency in a dynamic flow environment of a tube in exemplary embodiments of the disclosure: (a) schematic illustrating the conversion of the flat hierarchically structured substrate into a tubular form and subsequent lubricant infusion; (b) fluorescence images of tubular samples following 48 hours of bacterial flow (scale bars represent 50 μm); (c) relative area of fluorescence normalized to planar PDMS to allow for the quantification of collected images—area of fluorescence was used instead of number of cells to prevent misidentification of cell clusters; (d) fluorescence, scanning electron microscopy and optical images of the three tested conditions (scale bars on the scanning electron microscopy images represent 10 μM and those on the fluorescence images represent 50 μM)); (e) relative fluorescence of whole blood perfused tubes normalized to the planar condition (errors bars represent standard deviation and significance is shown through an asterisk corresponding to *P<0.05 and ***P<0.001).

FIG. 8 shows results obtained following 24 h perfusion of FITC-fibrinogen spiked human blood plasma in exemplary embodiments of the disclosure: the test was run using (a) planar-TPFS-PFPP and (b) hierarchically structured-TPFS-PFPP (scale bars represent 50 μm); (c) relative fluorescence intensity normalized to the planar-TPFS-PFPP condition (errors bars represent standard deviation and significance is shown through an asterisk corresponding to ***P<0.001).

### DESCRIPTION OF VARIOUS EMBODIMENTS

### 1. Definitions

Unless otherwise indicated, the definitions and embodiments described in this and other sections are intended to be applicable to all embodiments and aspects of the present disclosure herein described for which they are suitable as would be understood by a person skilled in the art. It is also to be understood that the terminology used herein is for the purpose of describing particular aspects only and is not intended to be limiting.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies. In addition, all ranges given herein include the end of the ranges and also any intermediate range points, whether explicitly stated or not.

As used in this disclosure, the singular forms “a”, “an” and “the” include plural references unless the content clearly dictates otherwise.

In embodiments comprising an “additional” or “second” component, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The abbreviation, “e.g.” is derived from the Latin exempli gratia and is used herein to indicate a non-limiting example. Thus, the abbreviation “e.g.” is synonymous with the term “for example.” The word “or” is intended to include “and” unless the context clearly indicates otherwise.

The term “wrinkling” as used herein refers to any process for forming wrinkles in a material.

The term “wrinkles” as used herein refers to microscale and/or nanoscale folds on a surface of a material.

The term “hierarchical” as used herein refers to a material having both microscale and nanoscale structural features on a surface of the material.

The term “omniphobic” as used herein in respect to a material refers to a material that exhibits both hydrophobic (low wettability for water and other polar liquids) and oleophobic (low wettability for low surface tension and nonpolar liquids) properties. Such omniphobic materials with high contact angles are often regarded as “self-cleaning” materials, as contaminants will typically bead up and roll off the surface.

The term “alkyl” as used herein, whether it is used alone or as part of another group, means straight or branched chain, saturated alkyl group, that is a saturated carbon chain that contains substituents on one of its ends. The number of carbon atoms that are possible in the referenced alkyl group are indicated by the numerical prefix “Cₙ₁₋ₙ₂”. For example, the term C₁₋₄alkyl means an alkyl group having 1, 2, 3 or 4 carbon atoms.

The term “alkylene” as used herein, whether it is used alone or as part of another group, means straight or branched chain, saturated alkylene group, that is a saturated carbon chain that contains substituents on two of its ends. The number of carbon atoms that are possible in the referenced alkylene group are indicated by the numerical prefix “Cₙ₁₋ₙ₂”. For example, the term C₁₋₆alkylene means an alkylene group having 1, 2, 3, 4, 5 or 6 carbon atoms.

The term “halo” as used herein refers to a halogen atom and includes F, Cl, Br and I.

The term “hydroxyl” as used herein refers to the functional group OH.

The term “suitable” as used herein means that the selection of the particular compound or conditions would depend on the specific synthetic manipulation to be performed, and the identity of the molecule(s) to be transformed, but the selection would be well within the skill of a person trained in the art. All process/method steps described herein are to be conducted under conditions for the reaction to proceed to a sufficient extent to provide the product shown. A person skilled in the art would understand that all reaction conditions, including, for example, reaction solvent, reaction time, reaction temperature, reaction pressure, reactant ratio and whether or not the reaction should be performed under an anhydrous or inert atmosphere, can be varied to optimize the yield of the desired product and it is within their skill to do so.

It will be understood that any component defined herein as being included may be explicitly excluded by way of proviso or negative limitation, such as any specific compounds or method steps, whether implicitly or explicitly defined herein.

### II. Methods and Compositions of the Disclosure

Described in the present disclosure is method of making a material that exhibits antibiofouling properties through a combination of surface hierarchy and maximized lubricant retention. Optionally, the material is flexible and/or transparent. The fabrication process is inexpensive and commercially scalable, while using biocompatible reagents that maximize the material's potential use within clinical settings. Herein, a strategy that transfers the wrinkled structures present on a mold, such as a polystyrene mold, with hierarchical surfaces onto elastomeric polymers, such as polydimethylsiloxane (PDMS) is disclosed. PDMS is a transparent, flexible and biocompatible elastomer that exhibits minimal fluorescence. Subsequent fluorosilane treatment and lubricant infusion are introduced to increase repellent properties. These lubricant-infused, hierarchically structured materials were tested with bacteria and blood to assess their suppression of biofilm formation and both blood staining and coagulation, respectively. The materials were then altered into a tubular form to assess their antibiofouling properties within clinically relevant flow conditions, ensuring their applicability in fluidic systems.

Accordingly, provided herein is a method of fabricating a material having a surface with hierarchical structures, the method comprising:
a) providing a mold comprising microscale wrinkles and nanoscale features,
b) depositing an elastomeric polymer onto the mold,
c) curing the elastomeric polymer on the mold to provide a cured elastomeric polymer,
d) removing the cured elastomeric polymer from the mold to expose a surface of the cured elastomeric polymer with hierarchical structures,
e) activating the surface of the elastomeric polymer by oxidation,
f) coating at least portion of the activated surface with a lubricant-tethering molecule to obtain at least one lubricant-tethering molecular layer on the activated surface of the elastomeric polymer.

Also provided herein is a method of fabricating a material having a surface with hierarchical structures, the method comprising:
a) depositing an elastomeric polymer onto a mold comprising microscale wrinkles and nanoscale features,
b) curing the elastomeric polymer on the mold to provide a cured elastomeric polymer,
c) removing the cured elastomeric polymer from the mold to expose a surface of the cured elastomeric polymer with hierarchical structures,
d) activating the surface of the elastomeric polymer by oxidation,
e) coating at least portion of the activated surface with a lubricant-tethering molecule to obtain at least one lubricant-tethering molecular layer on the activated surface of the elastomeric polymer.

Also provided herein is a method of fabricating a material having a surface with hierarchical structures, the method comprising:
a) depositing a moldable polymer onto a mold comprising microscale wrinkles and nanoscale features,
b) curing the moldable polymer on the mold to provide a cured polymer,
c) removing the cured polymer from the mold to expose at least a surface of the cured polymer with hierarchical structures,
d) activating at least the surface of the cured polymer by oxidation, and
e) coating at least portion of the activated surface with a lubricant-tethering molecule to obtain at least one lubricant-tethering molecular layer on the activated surface of the cured polymer.

Also provided herein is a method of fabricating a material having a surface with hierarchical structures, the method comprising:
a) obtaining a mold comprising microscale wrinkles and nanoscale features,
b) depositing an elastomeric polymer onto the mold,
c) curing the elastomeric polymer on the mold,
d) removing the elastomeric polymer from the mold to expose a surface with hierarchical structures,
e) activating the elastomeric polymer by oxidation of the surface,
f) coating the surface with a lubricant-tethering molecule to create at least one lubricant-tethering molecular layer.

The present disclosure provides a method of fabricating a material having a surface with hierarchical structures, the method comprising:
a) depositing a moldable polymer onto a mold comprising microscale wrinkles and nanoscale features,
b) curing the moldable polymer on the mold to provide a cured polymer, and
c) removing the cured polymer from the mold to expose at least a surface of the cured polymer with hierarchical structures.

In some embodiments, the method further comprises
d) activating at least the surface of the cured polymer by oxidation,
e) coating at least a portion of the activated surface with a lubricant-tethering molecule to obtain at least one lubricant-tethering molecular layer on at least a portion of the activated surface of the cured polymer.

In some embodiments, the moldable polymer is an elastomeric polymer, an un-cured elastomeric polymer or a thermoplastic polymer. Accordingly, in some embodiments, the cured polymer is a cured elastomeric polymer or a cured thermoplastic polymer.

In some embodiments, the moldable polymer that is deposited is an elastomeric polymer that uses a curing agent for curing, or an un-cured elastomeric polymer. In some embodiments such elastomeric polymers are known as polymer bases, polymer resins, base resins, or pre-polymers. In some embodiments, the depositing of the uncured elastomeric polymer comprises depositing of a curing agent with the elastomeric polymer. In some embodiments, the depositing of the curing agent is carried out as depositing of a mixture comprising the un-cured elastomeric polymer and the curing agent.

In some embodiments, the method further comprises depositing a lubricating layer on the at least one lubricant-tethering molecular layer after the coating.

In some embodiments, the method further comprises treating the mold with an anti-stick agent before the depositing. In some embodiments, the anti-stick agent comprises a fluorosilane, a fluorocarbon, a fluoropolymer, an organosilane, a polysiloxane, or mixtures thereof. In some embodiments, the anti-stick agent is a lubricating-tethering molecule.

In some embodiments, the method further comprises subjecting the mold with the deposited polymer to vacuum after the depositing. In some embodiments, vacuum is used as needed to remove any bubbles if present from the moldable polymer. In some embodiments, other methods to ensure the mold is properly filled with the moldable polymer, such as centrifugation, are used.

In some embodiments, the elastomeric polymer comprises a silicone elastomer. In some embodiments, the curing of the silicone elastomer is by a platinum-catalyzed cure, a condensation cure, a peroxide cure, or an oxime cure system. In some embodiments, the curing of the silicone elastomer is by heating. In some embodiments, the silicone elastomer is a commercially available silicone rubber, such as EcoFlex™.

In some embodiments, the curing of the elastomeric polymer is performed according to known procedures for curing the elastomeric polymer. In some embodiments, the curing is performed in the presence of a curing agent which is included with the elastomeric polymer when the elastomeric polymer is deposited onto the mold. In some embodiments, curing is performed with heating, for example at a temperature of about 50° C. to about 200° C., about 75° C. to about 175° C., about 100° C. to about 160° C. or about 150° C., for about 1 minute to about 1 hour, about 5 minutes to about 20 minutes, or about 10 minutes.

In some embodiments, the elastomeric polymer is polydimethylsiloxane (PDMS). In some embodiments, the PDMS is cured by heating, for example, at about 150° C. for about 10 minutes. In some embodiments, the elastomeric polymer comprises commercially available polysiloxane, such as Sylgard™.

In such embodiments, the transfer of the hierarchical structures from the mold to the polymer is performed via a hot embossing method.

In some embodiments, the activating of at least the surface of the cured polymer comprises introducing hydroxyl groups, in or on the cured polymer. In some embodiments, the activating comprises plasma treatment. In some embodiments, the activating comprises oxygen plasma treatment. In some embodiments, the plasma treatment is for a time of about 30 seconds to about 2 minutes, or about 1 minute.

In some embodiments, the activating comprises activating of more than the surface of the cure polymer, optionally, it comprises activating the whole of the cured polymer.

In some embodiments, the coating of the at least a portion of the activated surface with a lubricant-tethering molecule comprises chemical vapor deposition (CVD). In some embodiments, CVD is followed by a heat treatment, for example, heating at about 50° C. to about 150° C. for about 30 minutes to about 36 hours, or heating at about 60° C. overnight to about 120° C. for about one hour. In some embodiments, the coating is of the entirety of the activated surface.

In some embodiments, the lubricant-tethering molecule comprises a fluorosilane, a fluorocarbon, a fluoropolymer, an organosilane, a polysiloxane or mixtures thereof.

In some embodiments, the lubricant-tethering molecular layer is a fluorosilane layer and is formed using one or more compounds of the Formula I:

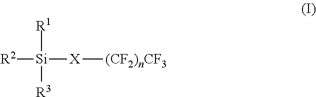

wherein X is a single bond or is C₁₋₆alkylene; n is an integer of 0 to 12; and R¹, R² and R³ are each independently a hydrolysable group.

In some embodiments, the polysiloxane is formed using one or more compounds of Formula II:

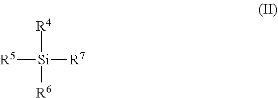

wherein R⁴, R⁵ and R⁶ are each independently a hydrolysable group; and R⁷ is C₁₋₃₀alkyl, optionally R⁷ is C₁₀₋₃₀alkyl or C₂₀₋₃₀alkyl.

It can be appreciated that a layer includes a monolayer and multilayer.

The hydrolysable groups, R¹, R², R³, R⁴, R⁵ and R⁶ are, independently any suitable hydrolysable group, the selection of which can be made by a person skilled in the art. In some embodiments, R¹, R², R³, R⁴, R⁵ and R⁶ are independently halo or —O—C₁₋₄alkyl. In some embodiments, R¹, R², R³, R⁴, R⁵ and R⁶ are each independently halo. In some embodiments, R¹, R², R³, R⁴, R⁵ and R⁶ are all independently —O—C₁₋₄alkyl. In some embodiments, R¹, R², R³, R⁴, R⁵ and R⁶ are all OEt. In some embodiments, R¹, R², R³, R⁴, R⁵ and R⁶ are all Cl. In some embodiments, X is C₁₋₆alkylene. In some embodiments, X is C₁₋₄alkylene. In some embodiments, X is —CH₂CH₂—. In some embodiments, n is an integer of 3 to 12. In some embodiments, n is an integer of 3 to 8. In some embodiments, n is an integer of 4 to 6. In some embodiments, n is 5. In some embodiments, R¹, R² and R³ are all Cl, X is —CH₂CH₂— and n is 5. In some embodiments, R¹, R² and R³ are all OEt, X is —CH₂CH₂— and n is 5.

In some embodiments, R⁴, R⁵ and R⁶ are all Cl. In some embodiments, R⁴, R⁵ and R⁶ are all OEt.

In some embodiments, the fluorosilane layer or monolayer is formed using any fluorocarbon-containing silanes such as, but not limited to, trichloro (1H,1H,2H,2H-perfluorooctyl)silane, 1H,1H,2H,2H-perfluorooctyltriethoxysilane, 1H,1H,2H,2H-perfluorodecyltriethoxysilane, 1H,1H,2H,2H-perfluorododecyltrichlorosilane, 1H,1H,2H,2H-perfluorodecyltrimethoxysilane, trimethoxy(3,3,3-trifluoropropyl)silane, (pentafluorophenyl)triethoxysilane, (3-glycidyloxypropyl)trimethoxysilane and heptadecafluoro-1,1,2,2-tetra-hydrodecyl trichlorosilane, and mixtures thereof.

In some embodiments, the fluorosilane comprises trichloro(1H,1H,2H,2H-perfluorooctyl)silane (TPFS) and/or a fluorosilane of similar composition. In some embodiments, the fluorosilane is commercially available.

In some embodiments, the mold comprises a surface having hierarchical structures of microscale wrinkles and nanoscale features. In some embodiments, the hierarchical structures of the mold are formed using a process comprising heat shrinking. In some embodiments, the mold comprises at least one nanoparticle layer and at least one lubricant-tethering molecular layer. In some embodiments, the mold is prepared using processes described in WO2020243833A1. In some embodiments, the omniphobic molecular layer lowers the surface energy of the material, increasing the omniphobic properties. In some embodiments, the omniphobic molecular layer comprises a fluorosilane.

It can be appreciated that the components of the lubricating layer are to be selected to be compatible with the lubricant-tethering molecular layer. In some embodiments, the lubricating layer comprises hydrocarbon liquid, fluorinated organic liquid, or perfluorinated organic liquid. In some embodiments, the lubricating layer comprises perfluorodecalin, silicone oil, poly(3.3.3-trifluoropropulmethylsiloxane), or mixtures thereof.

In some embodiments, the lubricating layer comprises perfluoroperhydrophenanthrene (PFPP).

Also provided herein is a material comprising a surface with hierarchical structures prepared using the method described herein. In some embodiments, the material exhibits both hydrophobic and oleophobic properties. In some embodiments, the material exhibits omniphobic properties. In some embodiments, the material exhibits water contact angles above 160°, hexadecane contact angles above 100° and water sliding angles below 5°.

In some embodiments, the material is flexible. In some embodiments, the moldable polymer, such as the elastomeric polymer or thermoplastic polymer, retains its inherent flexibility after completion of the method described herein. In some embodiments, the material is a flat flexible film. In some embodiments, the material has a thickness of about 0.3 mm to about 0.8 mm, or about 0.5 mm. It can be appreciated that since the material can be flexible, the material can be bent, folded or rolled to form different shapes. In some embodiments, the material is formed into a tubular shape.

In some embodiments, the material is transparent. In some embodiments, the moldable polymer, such as the elastomeric polymer or thermoplastic polymer, retains transparency after completion of the method described herein.

In some embodiments, the material exhibits anti-biofouling properties. In some embodiments, the material exhibits anti-biofouling properties in both static conditions and dynamic environments (i.e. flowing fluid conditions).

In some embodiments, the material exhibits repellency to liquids comprising biospecies. In some embodiments, biospecies include microorganisms such as bacteria, fungi, viruses or diseased cells, parasitized cells, cancer cells, foreign cells, stem cells, and infected cells. In some embodiments, biospecies also included biosepecies components such as cell organelles, cell fragments, proteins, nucleic acids vesicles, nanoparticles, biofilm, and biofilm components.

In some embodiments, the material exhibits repellency to bacteria and biofilm formation. In some embodiments, the surface exhibits repellency to bacteria and biofilm formation. In some embodiments, the bacteria are selected from one or more of gram-negative bacteria or gram-positive bacteria. In some embodiments, the bacteria are selected from one or more of Escherichia coli, Streptococcus species, Helicobacter pylon, Clostridium species and meningococcus. In some embodiments, the bacteria are gram-negative bacteria selected from one or more of Escherichia coli, Salmonella typhimurium, Helicobacter pylori, Pseudomonas aerugenosa, Neisseria meningitidis, Klebsiella aerogenes, Shigella sonnei, Brevundimonas diminuta, Hafnia alvei, Yersinia ruckeri, Actinobacillus actinomycetemcomitans, Achromobacter xylosoxidans, Moraxella osloensis, Acinetobacter lwoffi, and Serratia fonticola. In some embodiments, the bacteria are gram-positive bacteria selected from one or more of Listeria monocytogenes, Bacillus subtilis, Clostrdium difficile, Staphylococcus aureus, Enterococcus faecalis, Streptococcus pyogenes, Mycoplasma capricolum, Streptomyces violaceoruber, Corynebacterium diphtheria and Nocardia farcinica. In some embodiments, the bacteria are Pseudomonas aeruginosa or Staphylococcus aureus. In some embodiments, bacteria attachment is decreased by about 96%. For example, the decrease in bacteria attachment can be measured using assays measuring fluorescence assays or colony forming units of bacteria.

In some embodiments, the material exhibits repellency to water. In some embodiments, the material exhibits repellency to biological fluids. In some embodiments, the biological fluid is selected from the group consisting of whole blood, plasma, serum, sweat, feces, urine, saliva, tears, vaginal fluid, prostatic fluid, gingival fluid, amniotic fluid, intraocular fluid, cerebrospinal fluid, seminal fluid, sputum, ascites fluid, pus, nasopharengal fluid, wound exudate fluid, aqueous humour, vitreous humour, bile, cerumen, endolymph, perilymph, gastric juice, mucus, peritoneal fluid, pleural fluid, sebum, vomit, and combinations thereof.

In some embodiments, the material attenuates coagulation. In some embodiments, blood adhesion is decreased by about 95%. In some embodiments, the material exhibits antithrombogenic properties.

In some embodiments blood adhesion is determined by incubating materials in blood for about 20 minutes, then placing the materials into deionized water to allow blood adhered to the surface to mix into water by shaking the materials in the water for about 30 minutes before removing the materials from the water and taking absorbance values of water to determine changes in the amount of blood (hemoglobin) present on each surface.

In some embodiments, the material is not heat shrinkable. In some embodiments, the elastomeric polymer is not heat shrinkable. In some embodiments, the cured elastomeric polymer is not heat shrinkable.

Also provided herein is a device or article comprising the material described herein. In some embodiments, the material is on a surface of the device or article such as coated on the surface. In some embodiments, the material forms a surface of the device or article.

In some embodiments, the device or article is selected from any healthcare and laboratory device, personal protection equipment and medical device. In some embodiments, the device or article is selected from a cannula, a connector, a catheter, a catheter, a clamp, a skin hook, a cuff, a retractor, a shunt, a needle, a capillary tube, an endotracheal tube, a ventilator, a ventilator tubing, a drug delivery vehicle, a syringe, a microscope slide, a plate, a film, a laboratory work surface, a well, a well plate, a Petri dish, a tile, a jar, a flask, a beaker, a vial, a test tube, a tubing connector, a column, a container, a cuvette, a bottle, a drum, a vat, a tank, a dental tool, a dental implant, a biosensor, a bioelectrode, an endoscope, a mesh, a wound dressing, a vascular graft, and a combination thereof. In some embodiments, the device is a catheter, such as a urinary or intravenous catheter.

In some embodiments, the device is a biosensor, including, but not limited to, optical biosensors. In some embodiments, optical biosensors include fluorescence-based biosensors.

In some embodiments, the device is a wearable device or article. In some embodiments, the wearable device includes, but is not limited to, wearable biosensors comprising optical sensing components. In some embodiments, the wearable device is mounted on the eye, such as a contact lens-based sensor, or a skin-mounted device, such as a wireless health monitoring sensor.

Also provided herein is a device for preventing, reducing, or delaying adhesion, adsorption, surface-mediated clot formation, or coagulation of a biological material in contact therewith, comprising a low adhesion surface with hierarchical structures, at least one lubricant-tethering molecular layer and a lubricating layer, wherein the biological material is repelled from the surface. The present disclosure also provides a device comprising a low adhesion surface with hierarchical structures, wherein the surface comprises an elastomeric polymer, at least one lubricant-tethering molecular layer and a lubricating layer, wherein the surface comprises the material of the present disclosure, and wherein the surface is repellant against biological material. The present disclosure also provides a device of the present disclosure for use in preventing, reducing, or delaying adhesion, adsorption, surface-mediated clot formation or coagulation of a biological material in contact therewith.

Also provided herein is a method of preventing, reducing, or delaying adhesion, adsorption, surface-mediated clot formation, or coagulation of a biological material onto a device in contact therewith, the method comprising providing the device described herein and contacting the biological material to the low adhesion surface. The present disclosure also provides a method of preventing, reducing, or delaying adhesion, adsorption, surface-mediated clot formation, or coagulation of a biological material onto a device or article comprising surface-treating the device or article with a material of the present disclosure to obtain a low adhesion surface on the device or article. In some embodiments, the surface-treating comprises coating the device with the material of the present disclosure. In some embodiments, the surface-treating comprises forming a surface or a plurality of surfaces of the device with the material of the present disclosure.

### EXAMPLES

The following non-limiting examples are illustrative of the present disclosure:

### Example 1. Pattern Transfer and Characterization of Hierarchical Structures

### Materials and Methods

Reagents. Polydimethylsiloxane (SYLGARD 184) was purchased from Dow Corning (Midland, Michigan). Trichloro(1H,1H,2H,2H-perfuorooctyl)silane, (3-glycidyloxypropyl)trimethoxysilane and perfluoroperhydrophenanthrene were both purchased from Millipore Sigma (Oakville, Ontario).

Surface fabrication. PDMS was prepared through a 10 to 1 ratio by weight of base resin to curing agent. The mixture was stirred for 10 minutes and placed under vacuum for 20 minutes to remove bubbles. PDMS was then spread across the hierarchically structured polystyrene mold using a spatula to create a coating with a thickness of approximately 0.5 mm. To ensure that the PDMS filled the hierarchical structures on the mold, the PDMS-coated mold was placed under vacuum for 25 minutes. Subsequent heating at 150° C. for 10 minutes resulted in curing of the PDMS layer. A spatula was used to carefully separate the PDMS layer from the hierarchically structured mold. To induce hydroxyl groups on the surface for TPFS attachment, the PDMS substrates were oxygen plasma treated for 1 minute at 25° C. Placing the plasma treated substrates alongside 200 μL of TPFS under vacuum at −0.08 MPa for three hours led to the chemical vapor deposition of the silane onto the substrates. Overnight heat treatment at 60° C. ensured the development of a stable self-assembled monolayer of TPFS. PFPP was pipetted onto a substrate immediately prior its use, with excess lubricant being removed via tilting.

Contact and sliding angle measurements. All measurements consisted of at least three data points. A drop shape analyzer (DSA30, Krüss Scientific, Hamburg, Germany) was used for contact angle measurements. An automated syringe was used to dispense deionized water, while hexadecane and blood were dispensed manually using a pipette. All measurements were taken using droplet volumes of 2 μL. Measurements were taken using automated baseline configurations on an image processing software (Krüss ADVANCE). Sliding angles were measured using a digital angle level (ROK, Exeter, UK) with droplet volumes of 5 μL.

Scanning electron microscopy. Due to the micro- and nano-scale features of these surfaces, use of electron microscopy allowed for better conceptualization of the topography. Samples were prepared as described above and cut to size (˜0.5 cm×0.5 cm). For initial investigation, each sample was mounted using carbon tape and nickel paste, then coated with 5 nm of platinum using a sputter coater (Polaron model E1500, Polaron Equipment Ltd., Watford, Hertfordshire). For samples imaged following blood studies, osmium staining was performed prior to slow dehydration using ethanol. Once immersed in 100% ethanol, these biological samples were dried using the critical point dryer. Mounting and coating was then completed as above. Samples were imaged from a top-down perspective using the JEOL JSM-7000F.

Lubricant retention studies. Samples were cut using a biopsy punch to form discs with a diameter of 6 mm and weighed. 10 μL of PFPP was pipetted onto the surface of each sample and incubated for two minutes. Excess lubricant was tilted off the surface and samples were weighed. The difference between the weight before and after lubricant incubation provided a measure of lubricant retention.

### Results

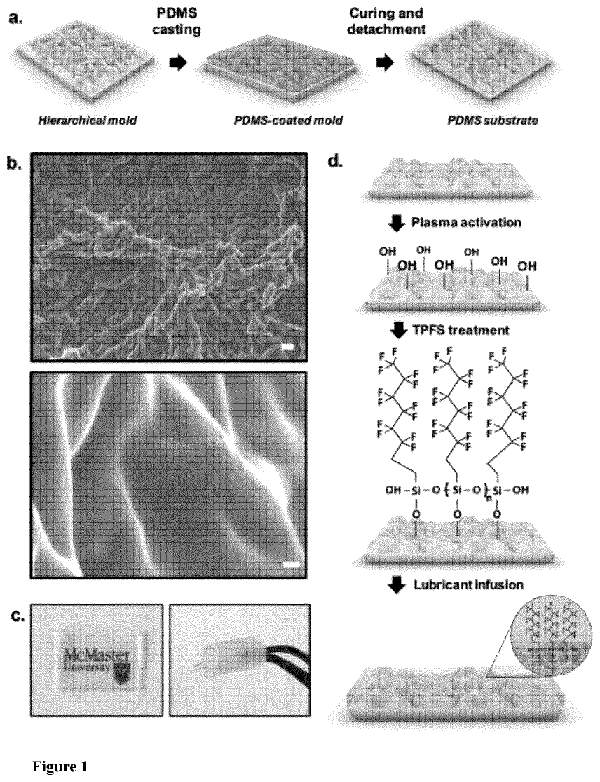

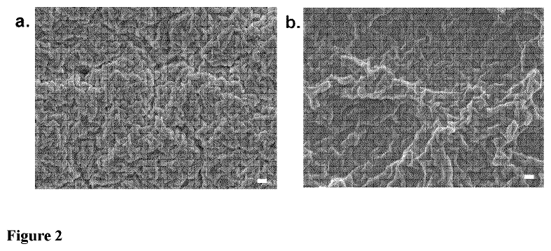

The preparation of hierarchical, wrinkled surfaces on heat shrinkable polymers has been reported previously.^{[5,6]} Briefly, silica nanoparticles were deposited onto an ultraviolet-ozone (UVO)-treated preshrunk polystyrene substrate. (3-aminopropyl)triethoxysilane was used as a crosslinker between the hydroxyl groups on the UVO-treated substrate and the nanoparticles. The nanoparticle-coated substrate was subsequently treated with a fluorosilane and thermally shrunk. The resulting substrates functioned as molds on which PDMS was casted. Pre-treatment of these molds with trichloro(1H,1H,2H,2H-perfluorooctyl)silane (TPFS) ensured that the casted polymer would be easily removed (FIG. 1a). Thin layers of PDMS were coated onto these hierarchical molds and subjected to vacuum to remove air pockets trapped between the micro/nanofeatures of the mold, thus maximizing the resolution of the transferred patterns. Following heat curing, the solidified PDMS layers were detached from the polystyrene molds to reveal negative prints of the structural features of the molds on PDMS (FIG. 2). Scanning electron microscopy (SEM) images verified the transfer of both the microscale structures and nanoscale features onto the PDMS substrate (FIG. 1b). These substrates also exhibited the high degrees of transparency and flexibility sought after, as depicted in FIG. 1c.

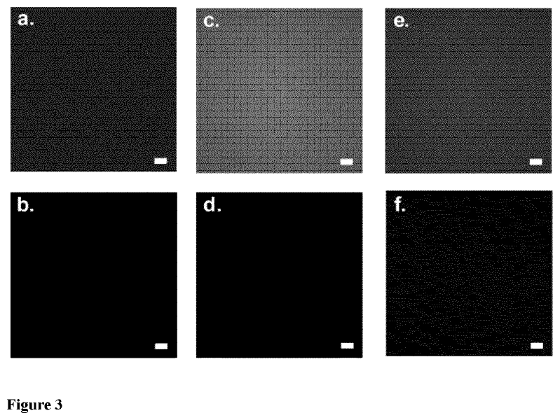

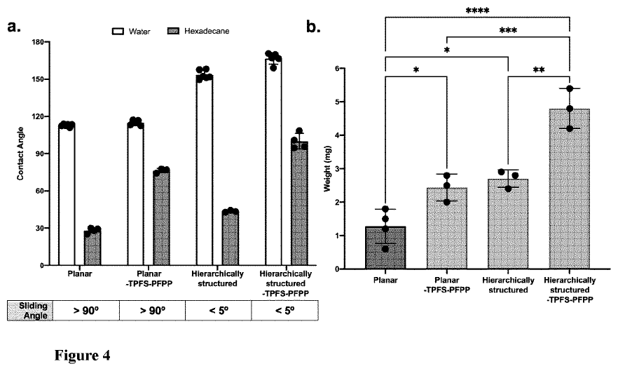

To understand the compatibility of these hierarchically structured PDMS substrates for sensing applications, their background fluorescence was assessed across three fluorescence channels and used the wrinkled polystyrene mold for comparison (FIG. 3). The PDMS substrates exhibited significantly lower fluorescence across all channels, indicating increased suitability for fluorescence-based sensing platforms relative to their polystyrene counterpart. Hierarchically structured PDMS substrates were then oxygen plasma activated and treated with TPFS to induce the formation of fluorocarbon self-assembled monolayers (FIG. 1d). Such monolayers exhibit high steric effects and low packing densities, resulting in improved surface repellency. Water (surface tension=71.99 mN/m) and hexadecane (surface tension=27.05 mN/m) were used to evaluate the repellency of hierarchically structured and hierarchically structured-TPFS surfaces—via contact angle (CA) and sliding angle (SA) measurements (FIG. 4a). Planar and planar-TPFS samples were used as controls. While planar PDMS had a CA of 112.8±1.1°, indicating hydrophobicity, hierarchically structured PDMS demonstrated superhydrophobic behaviour with a CA of 153.4±3.6°. While not wishing to be limited by theory, this increase can be attributed to the formation of a Cassie-Baxter wetting state, in which contact between water and the surface traps air in the grooves between the microstructures on the surface, inducing an increase in CA. Following TPFS treatment, planar PDMS showed marginally improved performance with a CA of 114.9±2.1°, while hierarchically structured-TPFS surfaces demonstrated a CA of 166.7±4.6°. The superhydrophobicity of the hierarchically structured and hierarchically structured-TPFS surfaces were further supported through sliding angles <5°, compared to sliding angles >900 for both planar and planar-TPFS. The role of TPFS treatment in improving omniphobicity was highlighted via hexadecane CAs, which increased from 28.1±2.1° to 76.3±1.8° for planar PDMS and from 43.5±0.7° to 100.0±6.3° for hierarchically structured PDMS.

In order to assess how the hierarchical structures interact with lubricant, differences in lubricant retention between the planar (control) and hierarchically structured PDMS substrates were then investigated (FIG. 4b), as well as their TPFS-treated counterparts. Samples were weighed before and after a short incubation with perfluoroperhydrophenanthrene (PFPP)—a biocompatible lubricant commonly used for clinical applications. Planar-TPFS exhibited an almost two-fold increase in lubricant retention relative to planar PDMS. While not wishing to be limited by theory, this increase can be attributed to the strong intermolecular interactions between the fluorine groups present on both PFPP and the treated surfaces. Texturing led to a two-fold increase in retention without TPFS (P<0.05). This can be credited to the larger surface area of hierarchically structured surfaces on which interactions between PFPP and the surface can form. Additionally, the grooves between the microscale structures provide pockets within which lubricant can pool in larger amounts. By combining wrinkling and TPFS treatment, a four-fold increase in lubricant retention was achieved relative to planar PDMS (P<0.001). Given its combination of strong omniphobic properties and efficient lubricant retention, it was next investigated whether the hierarchically structured surfaces with TPFS-PFPP modification exhibit antibiofouling properties towards bacteria and blood.

### Example 2. Bacterial Repellency of Hierarchically Structured PDMS Surfaces

### Materials and Methods

Reagents. Polydimethylsiloxane (SYLGARD 184) was purchased from Dow Corning (Midland, Michigan). Trichloro(1H,1H,2H,2H-perfuorooctyl)silane, (3-glycidyloxypropyl)trimethoxysilane and perfluoroperhydrophenanthrene were both purchased from Millipore Sigma (Oakville, Ontario). MOPS media was purchased from TekNova (Hollister, California, United States). TrypLE Express and FITC dye was purchased from Thermo Fisher Scientific (Burlington, ON, Canada).

Biofilm culture and experimental setup. Substrates were cut to size using a 6 mm biopsy punch to ensure consistency in the surface area of samples. 700 μL of 2% molten agarose (Bioshop, Burlington, Ontario) was added into the wells of a 48-well plate (Corning, United States). Samples were gently inserted into the agarose dispensed in each well. This ensured that the untreated sides and bottom surface of each substrate were inaccessible during testing. The wells were then left to dry overnight to allow the agarose inlay to solidify. Pseudomonas aeruginosa PA01 and Staphylococcus aureus USA300 JE2 (MRSA) were streaked from frozen onto LB agar and grown overnight at 37° C. From this, overnight cultures were diluted 1/100 into MOPS-minimal media supplemented with 0.4% glucose and 0.5% casamino acids (TekNova, United States) for P. aeruginosa, or tryptic soy broth supplemented with 0.4% glucose and 3% NaCl for MRSA. Each well of the previously prepared assay plates was flooded with 200 μl of the diluted bacterial suspension or control media in which bacterial cells were not present. The assay plates were then incubated without shaking at 37° C. for 72 h for P. aeruginosa and 24 h for MRSA to allow biofilms to form on the substrates. Following incubation, the agarose inlays containing the substrates were gently removed from each well using sterile forceps and placed within sterile petri dishes. Substrates were liberated from each agarose inlay by cutting surrounding agarose using forceps, then were gently submerged in sterile water three times to remove planktonic bacteria. Subsequently, the surfaces were placed into clean Petri dishes and allowed to dry at 37° C. for 30 minutes, before being transferred into fresh 48-well plates for downstream assays.

Colony forming unit (CFU)assay. To quantify colony forming units adhered to each surface, 200 μL of a recombinant trypsin solution (TrypLE Express, Gibco) was added to each well of the 48-well plate, covering the entirety of the surface. The sample plate was then incubated for 30 minutes at 37° C. with shaking to disperse biofilms and adhered bacterial cells from the surfaces. Colony forming units were quantified by plating serial dilutions from each well on LB agar Petri dishes.

### Results

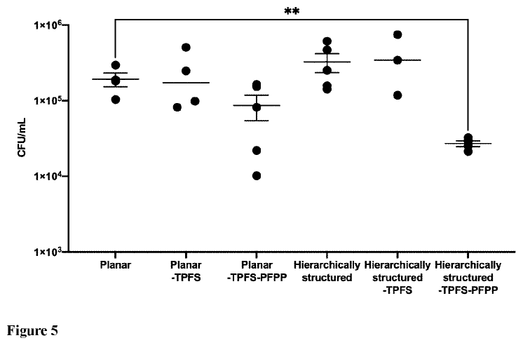

To understand how the surfaces interact with bacteria, bacterial adhesion and subsequent biofilm formation were investigated on four classes of PDMS surface: planar, planar-TPFS-PFPP, hierarchically structured, and hierarchically structured-TPFS-PFPP. Planar-TPFS and hierarchically structured-TPFS were included in some preliminary studies but performed similarly to their non-fluorinated counterpart (FIG. 5). Tests were conducted using Gram-positive methicillin-resistant Staphylococcus aureus (MRSA) and Gram-negative Pseudomonas aeruginosa because of the habitual presence of these pathogens in clinical environments.

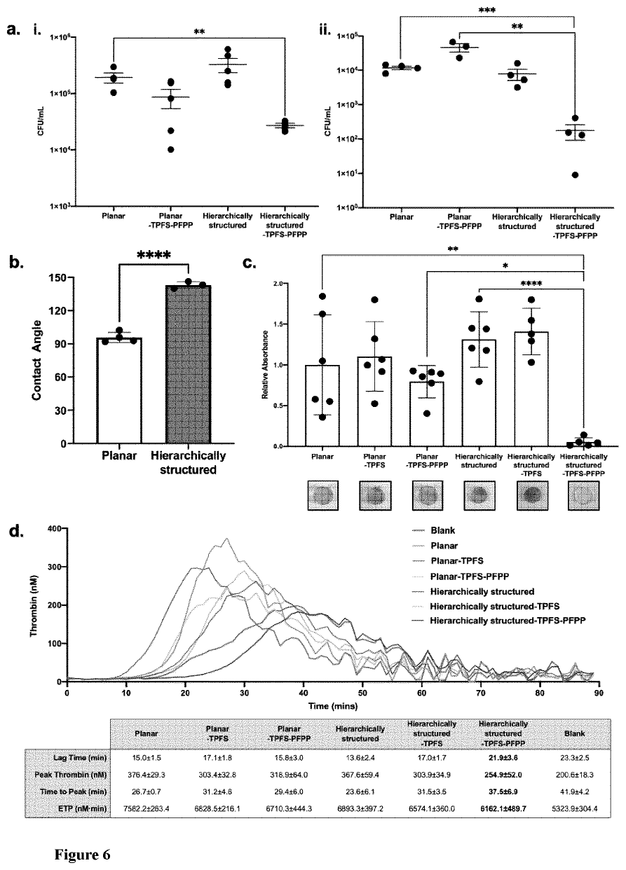

To detect differences in bacterial adhesion between testing conditions, samples were subjected to a colony forming unit (CFU) assay. Following overnight incubation in bacterial culture media and washing with sterile deionized water, samples were transferred into fresh bacterial growth media and agitated to release adhered bacteria and biofilms. The bacterial media were then serially diluted and CFUs were determined by plating onto agar plates. The resultant colony formation on agar plates was used to quantify the number of bacteria that was released from the surfaces into the growth media. Planar, planar-TPFS-PFPP and hierarchically structured samples incubated with MRSA showed mean bacterial presence in the range of 8.6×10⁴ to 3.3×10⁵ CFU/mL, with insignificant differences among the three conditions (FIG. 6a, i). The planar-TPFS-PFPP suffered from large sample-to-sample variability, highlighting the instability of the lubricant layer on its surface. In contrast, the hierarchically structured-TPFS-PFPP surfaces exhibited low sample-to-sample variation and demonstrated significantly lower bacterial presence approaching 1×10⁴ CFU/mL—a near one-log reduction relative to the planar condition, corresponding to an 86% reduction (P<0.01) in bacterial adhesion. With P. aeruginosa, planar, planar-TPFS-PFPP and hierarchically structured PDMS showed similar degrees of bacterial presence at approximately 1×10⁴ CFU/mL (FIG. 6a, ii). However, hierarchically structured -TPFS-PFPP showed a close to two-log reduction to 1×10² CFU/mL relative to the planar condition, corresponding to a 98.5% reduction in bacterial adhesion (P<0.001). It also showed a 99.6% reduction relative to the planar-TPFS-PFPP condition (P<0.01). The superior performance against P. aeruginosa compared to MRSA is attributed to its rod-shaped structure, which makes entrapment between the microscale hierarchically structured difficult as a result of steric hinderance; contrarily, the spherical shape of S. aureus allows for a degree of entrapment among the microscale structures on the developed surfaces. These studies show that the omniphobicity of the hierarchically structured-TPFS-PFPP surfaces translated to superior bacterial repellency compared to other hierarchically structured and planar surfaces tested herein.

### Example 3. Blood Repellency and Anticoagulatory Properties of Hierarchically Structured PDMS Surfaces

### Materials and Methods

Reagents. Polydimethylsiloxane (SYLGARD 184) was purchased from Dow Corning (Midland, Michigan). Trichloro(1H,1H,2H,2H-perfuorooctyl)silane, (3-glycidyloxypropyl)trimethoxysilane and perfluoroperhydrophenanthrene were both purchased from Millipore Sigma (Oakville, Ontario). N-2-Hydroxyethylpiperazine-N′-2-Ethanesulfonic Acid (HEPES) and calcium chloride were purchased from Bioshop Canada (Burlington, Ontario). The thrombin-directed fluorescent substrate, Z-Gly-Gly-Arg-AMC, was purchased from Bachem (Bubendorf, Switzerland). Pooled citrated plasma was collected from healthy donors as previously described.[_{7]} Venous blood was collected in tubes containing sodium citrate from healthy volunteers by a license phlebotomist. All procedures were approved by the McMaster University Research Ethics Board. Blood samples were collected from consenting in citrated BD collection tubes (Hamilton, Ontario) in line with procedures approved by the McMaster Research Ethics Board.

Blood staining assay. To test blood staining, samples were immersed in citrated human whole blood for 30 seconds and then transferred to a well filled with 700 μL of deionized water. A well plate (Corning, Canton, New York) containing all test samples immersed in water was placed on an incubating mini shaker (VWR, Mississauga, ON) for 30 minutes to release any blood adhered to the samples. 200 μL from each well containing a sample was transferred to a new well plate for optical density measurement using a plate reader (Synergy Neo2, BioTek, Winooski, Vermont). Blank wells contained 200 μL of deionized water.

Thrombin generation assay. To investigate the antithrombogenicity of the substrates, a fluorogenic thrombin generation assay was performed. Samples were cut to size using a 6 mm biopsy punch and affixed to the bottom of a black, flat-bottom 96-well plate (Evergreen Scientific, Vernon, CA, USA) using Elkem Silbione adhesive glue (Factor II, Lakeside, AZ). Empty wells were used as controls. 80 μL of citrated plasma was added to each well, followed by 20 μL of 20 mM HEPES buffer (pH 7.4). Plates were then incubated at 37° C. for 10-15 minutes. A fluorogenic solution was created using HEPES buffer with final fluorogenic substrate concentration of 20 mM Z-Gly-Gly-Arg-AMC (zGGR) and 25 mM of CaCl2. To initiate clotting after incubation, 100 μL of fluorogenic solution was added to each well. Plates were immediately loaded into the SPECTRAmax fluorescence plate reader (Molecular Devices) to monitor substrate hydrolysis at 1-minute intervals for 90 minutes using excitation wavelength of 360 nm and emission wavelength of 460 nm. Data collected was analyzed using the Technoclone software—Technothrombin TGA protocol (Vienna, Austria). Lag time to thrombin generation (minutes), peak thrombin concentration (nM), time to peak thrombin concentration (minutes) and area under the curve or endogenous thrombin potential (ETP) (nM·min) were calculated using software and reported.

### Results

As a preliminary assessment of blood repellency, the CA of human whole blood (surface tension=˜55 mN/m) was measured on both planar and hierarchically structured surfaces (FIG. 6b). Planar PDMS showed a CA of 95.8±4.7°; however, hierarchically structured PDMS exhibited a CA of 143.2±3.1°, thus demonstrating significantly improved repellency (P<0.0001). Subsequent blood studies assessed the performance of six conditions: planar, planar-TPFS, planar-TPFS-PFPP, hierarchically structured, hierarchically structured-TPFS and hierarchically structured-TPFS-PFPP. To investigate adherence in an environment that induces greater contact with blood, samples were subjected to a blood staining assay (FIG. 6c) in which the substrates were immersed into anticoagulated human whole blood. After submerging into blood, the surfaces were subsequently added into wells containing water and agitation to release any adhered blood. The absorbance of the solution released from the surfaces was measured using spectrophotometry. Hierarchically structured PDMS performed 30% worse than planar PDMS, while planar-TPFS and hierarchically structured-TPFS showed marginally worse performance compared to their untreated counterparts, with an increase of 10% and 7% in absorbance, respectively. All three of these increases in blood adhesion can be attributed to hydrophobic interactions between these surfaces and blood proteins, given that both surface wrinkling and TPFS treatment enhance hydrophobicity. With the introduction of lubricant, planar-TPFS-PFPP showed a statistically insignificant improvement in performance relative to planar PDMS. However, hierarchically structured-TPFS-PFPP showed a 95% and 96% improvement over planar PDMS and untreated hierarchically structured PDMS, respectively (P<0.01, P<0.0001). Based on these observed blood repellent properties, it was further investigated whether hierarchically structured-TPFS-PFPP surfaces possess antifouling properties in environments that involve increased blood contact durations and the induction of clotting.

To determine whether the observed blood repellency translated to reduced thrombogenicity, a thrombin generation assay was conducted (FIG. 6d). Lag time, peak thrombin, time to peak thrombin and endogenous thrombin potential were assessed, with all four parameters showing similar trends in performance among the tested conditions. Planar-TPFS and planar-TPFS-PFPP showed marginal improvements across all four measures relative to untreated planar PDMS. Hierarchically structured and hierarchically structured-TPFS performed slightly better than their planar counterparts. All these surfaces still induced significant thrombin generation relative to background conditions. On the other hand, the hierarchically structured-TPFS-PFPP surfaces showed strong antithrombotic properties that were at or approaching background levels. This condition significantly outperformed all other conditions, as detailed in Table 1. The antithrombogenicity of hierarchically structured-TPFS-PFPP surfaces supported their application within clinical devices and thus substantiated the need for subsequent studies investigating such properties in a dynamic environment.

Table 1. An overview of the P-values obtained through an analysis of variance comparing hierarchically structured-TPFS-PFPP against all other test conditions in the thrombin generation assay. Significance is established in at least one test parameter for every condition, with most conditions exhibiting significance across all parameters. NS indicated no statistical significance, but an improvement in performance relative to the hierarchically structured-TPFS-PFPP condition was still observed.

| | Lag | Peak | Time to | |
|---|---|---|---|---|
| | Time | Thrombin | Peak | ETP |
| Planar | <0.0001 | <0.0001 | 0.0007 | <0.0001 |
| Planer-TPFS | 0.0010 | NS | NS | 0.0026 |
| Planar-TPFS-PFPP | <0.0001 | 0.0422 | 0.106 | 0.0215 |
| Hierarchically | <0.0001 | 0.0002 | <0.0001 | 0.0039 |
| structured | | | | |
| Hierarchically | 0.0008 | NS | NS | NS |
| structured-TPFS | | | | |

### Example 4. Hierarchically Structured PDMS Repellency in Dynamic Conditions

### Materials and Methods

Reagents. Polydimethylsiloxane (SYLGARD 184) was purchased from Dow Corning (Midland, Michigan). Trichloro(1H,1H,2H,2H-perfuorooctyl)silane, (3-glycidyloxypropyl)trimethoxysilane and perfluoroperhydrophenanthrene were both purchased from Millipore Sigma (Oakville, Ontario). Phosphate buffered saline (pH 7.4) was purchased from Bioshop Canada (Burlington, ON). FITC conjugated human fibrinogen, N-2-Hydroxyethylpiperazine-N′-2-Ethanesulfonic Acid (HEPES) and calcium chloride were purchased from Bioshop Canada (Burlington, Ontario). FITC dye was purchased from Thermo Fisher Scientific (Burlington, ON, Canada). The thrombin-directed fluorescent substrate, Z-Gly-Gly-Arg-AMC, was purchased from Bachem (Bubendorf, Switzerland). Pooled citrated plasma was collected from healthy donors as previously described.[_{7]} Venous blood was collected in tubes containing sodium citrate from healthy volunteers by a license phlebotomist. All procedures were approved by the McMaster University Research Ethics Board. Blood samples were collected from consenting in citrated BD collection tubes (Hamilton, Ontario) in line with procedures approved by the McMaster Research Ethics Board. E. coli K-12 MG1655 transfected with pUA66-GadB with green fluorescent protein (GFP) were generously offered by the Brown Lab at McMaster University (Hamilton, Ontario).

Fabrication of tubular test devices. Test surfaces were furled into 1 mL syringe barrels (BD, Mississauga, Ontario), which provided a structural scaffold. The width of the test surfaces was equal to the circumference of the barrels to create an even testing interface. Attachment to a second syringe barrel using epoxy glue (Gorilla Glue, Sharonville, Ohio) resulted in a luer lock on each end of the test device. Female barbed luer connectors (0.89 mm ID, Quosina®, Ronkonkoma, New York) were added at each end to allow for attachment to silicone tubing. The resulting devices had an inner diameter of 3.78 mm.

Bacterial flow assay. For E. coli perfusion experiments, a perfusion media consisting of 6 mL of E. coli K12 MG1655 harboring green fluorescent protein-expressing pUA66-GadB (10⁶ CFU/mL diluted in PBS) was formulated and mixed in the presence of a flame to prevent aerosolized contamination. A 4-channel peristaltic pump (Ismatec Reglo, Cole Parmer®, Montreal, Quebec) was connected to sterilized tubing (0.89 mm ID, Tygon, Pennsylvania, United States) and the tubular test devices were to form a closed loop. The loop was rinsed with 70% ethanol and then PBS at a flow rate of 3 ml/min. Four collection tubes (Corning, Canton, New York) containing 6 mL each of GFP-E. coli were subsequently drawn and loaded into the peristaltic pumping reservoir. Pumping was initiated with a flow rate of 1 mL/min. The bacterial media was perfused for 48 hours. Following perfusion, the test surfaces were gently removed from the system and rinsed in a stationary sterile PBS wash reservoir. Following rinsing, the surfaces were imaged using fluorescence microscopy (Eclipse Ti2 Series, Nikon®, Melville, New York).

FITC-fibrinogen preparation. 10 mg of peak 1 fibrinogen was dissolved with FITC dye (Invitrogen, Thermo Fisher Scientific) and the reaction was incubated for 1 hour in the dark at RT. The reaction was passed through a PD-10 column packed with Sephadex G-25 beads, and 1 mL fractions were collected following incubation. Absorbance was read using a spectrophotometer at 280 nm, and 494 nm and protein concentration were determined.

Blood plasma perfusion assay. A perfusion media containing equal parts human platelet poor plasma and a HEPES-FITC-fibrinogen solution (175 ug/mL final concentration) was formulated at room temperature and gently mixed for 30 seconds via pipetting. Simultaneously, a 4-channel peristaltic pump (Ismatec Reglo, Cole Parmer®, Montreal, Quebec) was connected, and sterilized tubing was rinsed at high flow rate (3 mL/minute) with HEPES buffer. Four collection tubes, containing 6 mL each of plasma-HEPES-FITC-fibrinogen solution were subsequently drawn and loaded into the peristaltic pumping reservoir. After connecting the tubular test devices, this closed loop was primed with the solution. Pumping was then initiated at a flow rate of 1 mL/min for a period of 24 hours. Following perfusion, the test surfaces were gently removed from the system and rinsed in a stationary HEPES wash reservoir. Following rinsing, the surfaces were imaged using fluorescence microscopy.

Whole blood perfusion assay. A perfusion media containing equal parts citrated human whole blood and HEPES-FITC-fibrinogen solution (175 ug/ml final concentration) was formulated following a protocol identical to that used for the plasma perfusion study. An 8-channel syringe pump (New Era Pump Systems®, Farmingdale, New York) was connected, and sterilized tubing was with HEPES buffer at a flow rate of 3 mL/min. Four collection tubes, containing 5 mL each of whole blood-HEPES-FITC-fibrinogen were then drawn, and spiked with IM calcium chloride solution (12.5 mM final concentration) to restore coagulant activity. The contents were mixed for 30 seconds and immediately transferred to 5 mL needle-tipped syringes (BD, Mississauga, Ontario), which were loaded into the syringe pump. The tubular test devices were then attached, and the system was primed with whole blood-HEPES-FITC-fibrinogen solution. Pumping was initiated with a flow rate of 1 mL/min, but with a reduced perfusion time equal to the point of tubular occlusion—approximately 25 minutes. At this point, the devices usually became occluded, preventing further perfusion. Following perfusion, surfaces were removed and rinsed in a HEPES wash reservoir and imaged using both fluorescence microscopy and a digital color camera.

### Results

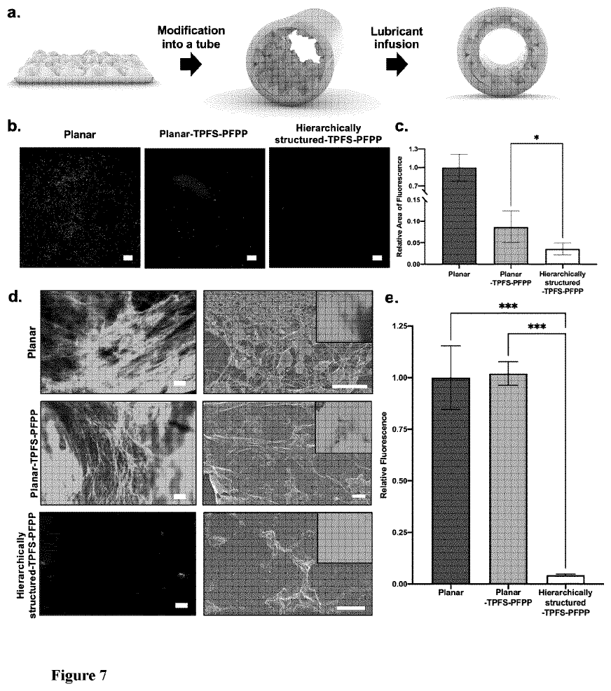

While the hierarchically structured-TPFS-PFPP surfaces showed excellent antibiofouling properties in static conditions, the dynamic environment within various biomedical devices and sensing platforms presents vastly different physical and mechanical conditions that need to be considered. Thus, the developed surfaces were tested under flow to ensure viability with such applications. The high flexibility of the substrates allowed for their alteration from flat surfaces into tubular devices (FIG. 7a). Planar, planar-TPFS-PFPP and hierarchically structured-TPFS-PFPP substrates were studied in such conditions.

To test bacterial repellency, Escherichia coli K12 constitutively expressing green fluorescent protein was diluted in phosphate buffered saline (PBS) to a concentration of 10⁶ CFU/mL and flowed through the tubular devices for 48 hours. Following perfusion, the tubes were cut open, washed and imaged using fluorescence microscopy (FIG. 7b). The planar tubes showed significant bacterial attachment, as indicated by the homogeneous coverage of fluorescent spots across the surfaces. The planar-TPFS-PFPP tubes showed significant improvement relative to the non-lubricant tubes; however, the hierarchically structured-TPFS-PFPP surfaces significantly outperformed both planar conditions, showing very minimal bacterial attachment. The degree of bacterial attachment was quantified based on the area covered with fluorescent bacteria (FIG. 7c). Planar-TPFS-PFPP showed a 92.5% reduction in bacterial attachment relative to planar PDMS, while hierarchically structured-TPFS-PFPP showed a 96.5% reduction relative to planar PDMS (P<0.0001, P<0.0001). Hierarchically structured-TPFS-PFPP showed a 53% reduction compared to planar-TPFS-PFPP (P<0.05) indicating the effect of hierarchical structures on PDMS tubes for the prevention of bacterial adhesion.

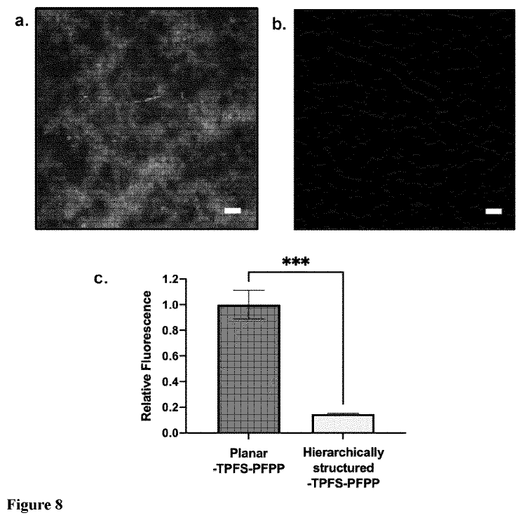

Blood adhesion and clotting were also explored under flow. Citrated human blood plasma was studied first to allow for a long perfusion time while minimizing the possibility of clotting. FITC-fibrinogen was added to the plasma so that adherent fibrin networks could be visualized by monitoring fluorescence. The mixture was perfused through planar-TPFS-PFPP and hierarchically structured-TPFS-PFPP tubes using pulsatile flow for 24 hours after which samples were cut open, briefly washed and imaged (FIG. 8). The planar-TPFS-PFPP surface showed an abundance of fibrin networks heavily coating the surface. In contrast, the hierarchically structured-TPFS-PFPP exhibited minimal fibrin attachment despite the prolonged perfusion duration, as indicated by an 85% reduction in fluorescently labelled fibrin (P<0.001).

To better replicate clinical conditions, flow studies were then run using citrated human whole blood to which FITC-fibrinogen was added. The blood was perfused through planar, planar-TPFS-PFPP and hierarchically structured-TPFS-PFPP tubes. Calcium chloride was added to the blood immediately before perfusion to induce clotting. Flow continued until the tubes occluded, at which point samples were optically and fluorescently imaged (FIG. 7d). The planar PDMS tubes demonstrated extensive blood staining and dense fluorescent fibrin networks were observed across the entirety of the surface. Planar-TPFS-PFPP exhibited less staining but a similar abundance of fibrin networks, mimicking what was observed in the plasma study. Again, hierarchically structured-TPFS-PFPP tubes showed very minimal blood staining and no fibrin networks, as evidenced by a 95.8% reduction in fluorescence compared with either planar condition (FIG. 7e, P<0.001, P<0.001). These samples were then imaged via SEM to visualize clots formed on the surface. The planar PDMS surface revealed extensive clotting, with red blood cells and fibrin networks decorating the entire surface (FIG. 8d). Planar-TPFS-PFPP showed some attachment of fibrin onto the substrate, but less than that observed on non-lubricated counterparts. The hierarchically structured-TPFS-PFPP substrate showed no signs of clotting or cell attachment, verifying its repellent and antithrombotic properties under flow. The change in the appearance of the hierarchically structures was verified to be due to the osmium coating used for SEM sample preparation. Collectively, the effectiveness of hierarchically structured-TPFS-PFPP tubes in preventing biofouling under dynamic conditions confirms their ability to address existing gaps in the biomedical space—particularly within in vivo devices such as intravenous and urinary catheters, which currently suffer from extensive biofouling.

### CONCLUSION

Using a pattern transfer protocol, an inexpensive, antibiofouling substrate that addresses a gap in the biomedical space though its optical transparency and high degree of flexibility has been developed. The combination of hierarchical structuring and lubricant infusion on these substrates results in significant repellency towards biological entities. As demonstrated by relevant control conditions, the hierarchical structuring serves two purposes in relation to repellency: liquid repellency through the induction of a Cassie-Baxter wetting state and omniphobicity through increased TPFS-mediated lubricant retention.

Through its effectiveness in preventing biofouling against bacteria and blood in both static and dynamic conditions, this surface exhibits properties that would make it applicable within various biomedical platforms. For example, chip-based and wearable biosensors suffering from the non-specific attachment of biological entities and biomedical devices prone to biofilm formation and thrombosis stand to benefit from the developed substrate. Given their tendency to promote both infection and blood-related complications, urinary and intravenous catheters in particular, present a promising application for the developed substrate, especially given its excellent performance under flow, where lengthy perfusion times did not lead to a deterioration in performance. Ultimately, incorporation of this lubricant-infused, hierarchically structured substrate into existing biomedical devices and sensors would help to improve performance and resultant clinical outcomes.

While the present disclosure has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

### REFERENCES

(1) Leslie, D. C.; Waterhouse, A.; Berthet, J. B.; Valentin, T. M.; Watters, A. L.; Jain, A.; Kim, P.; Hatton, B. D.; Nedder, A.; Donovan, K.; Super, E. H.; Howell, C.; Johnson, C. P.; Vu, T. L.; Bolgen, D. E.; Rifai, S.; Hansen, A. R.; Aizenberg, M.; Super, M.; Aizenberg, J.; Ingber, D. E. A Bioinspired Omniphobic Surface Coating on Medical Devices Prevents Thrombosis and Biofouling. Nature Biotechnology 2014, 32 (11), 1134-1140. https://doi.org/10.1038/nbt.3020.
(2) Kim, P.; Kreder, M. J.; Alvarenga, J.; Aizenberg, J. Hierarchical or Not? Effect of the Length Scale and Hierarchy of the Surface Roughness on Omniphobicity of Lubricant-Infused Substrates. Nano Lett. 2013, 13 (4), 1793-1799. https://doi.org/10.1021/n14003969.
(3) Ware, C. S.; Smith-Palmer, T.; Peppou-Chapman, S.; Scarratt, L. R. J.; Humphries, E. M.; Balzer, D.; Neto, C. Marine Antifouling Behavior of Lubricant-Infused Nanowrinkled Polymeric Surfaces. ACS Appl. Mater. Interfaces 2018, 10 (4), 4173-4182. https://doi.org/10.1021/acsami.7b14736.
(4) Wong, T.-S.; Kang, S. H.; Tang, S. K. Y.; Smythe, E. J.; Hatton, B. D.; Grinthal, A.; Aizenberg, J. Bioinspired Self-Repairing Slippery Surfaces with Pressure-Stable Omniphobicity. Nature 2011, 477 (7365), 443-447. https://doi.org/10.1038/nature10447.
(5) Imani, S. M.; Maclachlan, R.; Rachwalski, K.; Chan, Y.; Lee, B.; McInnes, M.; Grandfield, K.; Brown, E. D.; Didar, T. F.; Soleymani, L. Flexible Hierarchical Wraps Repel Drug-Resistant Gram-Negative and Positive Bacteria. ACS Nano 2020, 14 (1), 454-465. https://doi.org/10.1021/acsnano.9b06287.
(6) Imani, S. M.; Maclachlan, R.; Chan, Y.; Shakeri, A.; Soleymani, L.; Didar, T. F. Hierarchical Structures, with Submillimeter Patterns, Micrometer Wrinkles, and Nanoscale Decorations, Suppress Biofouling and Enable Rapid Droplet Digitization. Small 2020, 16 (50), 2004886. https://doi.org/10.1002/smll.202004886.
(7) Yau, J. W.; Stafford, A. R.; Liao, P.; Fredenburgh, J. C.; Roberts, R.; Weitz, J. I. Mechanism of Catheter Thrombosis: Comparison of the Antithrombotic Activities of Fondaparinux, Enoxaparin, and Heparin in Vitro and in Vivo. Blood 2011, 118 (25), 6667-6674. https://doi.org/10.1182/blood-2011-07-364141.

1. A method of fabricating a material having a surface with hierarchical structures, the method comprising:
a) depositing a moldable polymer onto a mold comprising microscale wrinkles and nanoscale features,
b) curing the moldable polymer on the mold to provide a cured polymer, and
c) removing the cured polymer from the mold to expose at least a surface of the cured polymer with hierarchical structures.

2. The method of claim 1, further comprising
d) activating at least the surface of the cured polymer by oxidation,
e) coating at least a portion of the activated surface with a lubricant-tethering molecule to obtain at least one lubricant-tethering molecular layer on at least a portion of the activated surface of the cured polymer.

3. The method of claim 2, wherein the coating of the surface with the lubricant-tethering molecule comprises chemical vapor deposition of the lubricant-tethering molecule onto the surface.

4. The method of claim 2, wherein the lubricant-tethering molecule comprises a fluorosilane, a fluorocarbon, a fluoropolymer, an organosilane, a polysiloxane or mixtures thereof.

5. The method of claim 4, wherein the polysiloxane is formed using one or more compounds of Formula II 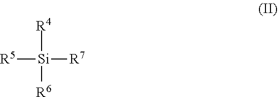
wherein R⁴, R⁵ and R⁶ are each independently a hydrolysable group; and R⁷ is C₁₋₃₀alkyl.

6. The method of any-ene-of-claims 24e-5, wherein the lubricant-tethering molecule layer is a fluorosilane layer and is formed using one or more compounds of the Formula I: 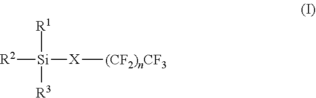
wherein X is a single bond or is C₁₋₆alkylene; n is an integer of 0 to 12; and R¹, R² and R³ are each independently a hydrolysable group.

7. (canceled)

8. The method of claim 2, further comprising depositing a lubricating layer on the at least one lubricant-tethering molecular layer after the coating.

9. The method of claim 8, wherein the lubricating layer comprises hydrocarbon liquid, fluorinated organic liquid, or perfluorinated organic liquid.

10. (canceled)

11. The method of claim 2, wherein the activating of at least the surface of the cured polymer comprises plasma treatment.

12. The method of claim 2, wherein the mold comprises a surface having hierarchical structures of microscale wrinkles and nanoscale features, at least one nanoparticle layer and at least one lubricant-tethering molecular layer.

13. The method of claim 2, further comprising subjecting the mold with the deposited moldable polymer to vacuum after the depositing.

14. The method of claim 2, wherein the moldable polymer is an elastomeric polymer, an un-cured elastomeric polymer or a thermoplastic polymer.

15. (canceled)

16. The method of claim 14, wherein the elastomeric polymer comprises a silicone elastomer.

17. (canceled)

18. The method of claim 2, wherein the material is flexible, the material is transparent, the material exhibits repellency to liquids comprising biospecies, the material exhibits repellency to bacteria and biofilm formation, the material exhibits repellency to biological fluids or the material attenuates coagulation.

19. (canceled)

20. (canceled)

21. (canceled)

22. (canceled)

23. The method of claim 2, wherein the material exhibits repellency to blood.

24. (canceled)

25. The method of claim 2, wherein the material is not heat shrinkable, wherein the moldable polymer is not heat shrinkable, or wherein the cured polymer is not heat shrinkable.

26. A material comprising a surface with hierarchical structures prepared using the method of claim 2.

27. A device or article comprising the material of claim 26.

28. The device of claim 27, wherein the material is on a surface of the device or article, or wherein the material forms a surface of the device or article.

29. (canceled)

30. A method of preventing, reducing, or delaying adhesion, adsorption, surface-mediated clot formation, or coagulation of a biological material onto a device or article comprising surface-treating the device or article with a material of claim 26 to obtain a low adhesion surface on the device or article.
